(19) United States
(12) Patent Application Publication
(10) Pub. No.: US 2010/0050792 A1
(43) Pub. Date: Mar. 4, 2010

(54) PREPARING SENSORS WITH NANO STRUCTURE

(75) Inventor: Kwangyeol Lee, Gyeongkido (KR)

Correspondence Address: EDWARDS ANGELL PALMER & DODGE LLP, P.O. BOX 55874, BOSTON, MA, 02205, US

(73) Assignee: Korea University Industrial & Academic Collaboration Foundation, Seoul (KR)

(21) Appl. No.: 12/199,731

(22) Filed: Aug. 27, 2008

(51) Int. Cl. G01M 19/00; B29B 9/00; B05D 5/12; B29C 41/24

(52) U.S. Cl. 73/865.8; 425/6; 427/77; 264/165; 977/762; 977/932

(57) ABSTRACT

A sensor producing apparatus comprised of an extractor for extracting a nano fiber from a solution and a driving device to relatively move the substrate and the extractor, a method for forming a sensor, and a sensor with a nano structure are provided.

### TECHNICAL FIELD

The present disclosure relates generally to sensors and, more particularly, to sensors with a nano structure.

### BACKGROUND

Sensors capable of detecting gas, chemical materials, bio-molecules may be used in a variety of fields such as chemistry, pharmacy, food, agriculture, environment management, and a medical field. For certain sensors, characteristics such as speed, selectivity, sensitivity, reproducibility, durability, low-consumption power, integration may be required.

### SUMMARY

A sensor producing apparatus, including a substrate, an extractor configured to extract a nano fiber from a solution and a driving device configured to provide relative movement between the substrate and the extractor may be provided. The sensor may include a nano structure.

In some examples, methods for preparing a sensor may be provided.

The Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a diagram of an illustrative embodiment of an extraction of a fiber by electro-spinning.

FIG. 2A is a diagram of an illustrative embodiment of a nano fiber arranged on a substrate.

FIG. 2B is a diagram of an illustrative embodiment of a nano fiber arranged on a substrate.

FIG. 3 is a diagram of an illustrative embodiment of a plurality of electrodes formed at positions corresponding to the positions of a nano fiber on a substrate.

FIG. 4 is a diagram of an illustrative embodiment of an arrangement form of nano loads in a nano fiber.

FIG. 5 is top view of an illustrative embodiment of a sensor unit including a metal layer.

FIG. 6 is a diagram of an illustrative embodiment of a separation line of a substrate.

### DETAILED DESCRIPTION

In the following detailed description, reference is made to the accompanying drawings, which form a part hereof. In the drawings, similar symbols typically identify similar components, unless dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and made part of this disclosure.

Sensors including a nano wire may include electrodes for each of the arranged nano wires. Further, the arrangement of the nano structure arranged between the electrodes may be related to a transmission rate of electrons through the nano structure, so that the arrangement may affect the response performance of the sensor.

In one embodiment, an apparatus for preparing a sensor may include a substrate, an extractor configured to extract a nano fiber from a solution, and a driving device configured to move the substrate and the extractor relative to each other. By operating to move the substrate and the extractor relatively, the nano fiber on the substrate may be arranged with a specific alignment. The driving device may be mounted on the extractor, the substrate, or both the extractor and the substrate, and it may be programmed to control the arrangement of the nano fiber with a predetermined track. The apparatus may prepare a plurality of sensors on one substrate and divide the substrate to fabricate a plurality of sensors.

In another embodiment, a method for preparing sensors may include arranging a nano fiber extracted from a solution on a substrate, and the nano fiber may be extracted moving relatively to the substrate. A plurality of electrodes may be provided at some positions of the substrate where the nano fiber may be arranged. The extracted nano fiber may be arranged along a predetermined track relative to the substrate. A plurality of electrodes may be formed at the position the nano fiber may be arranged. In an example, the electrodes may be formed on the substrate before the extraction of the nano fiber, and the nano fiber may be arranged to a position corresponding to the electrodes. A heat treatment may be provided, and a plurality of individual nano sensors may be prepared by dividing the substrate.

In one embodiment, a sensor may include a substrate having a plurality of electrodes, and a nano structure formed in a position corresponding to the plurality of electrodes, and the nano nano structure may include nano loads. The nano loads may be substantially aligned with a direction that the nano structure is arranged. The sensors may further include a conductive metal layer formed on the plurality of electrodes.

Hereinafter, embodiments may be explained with reference to the drawings.

### Extraction of Nano Fiber

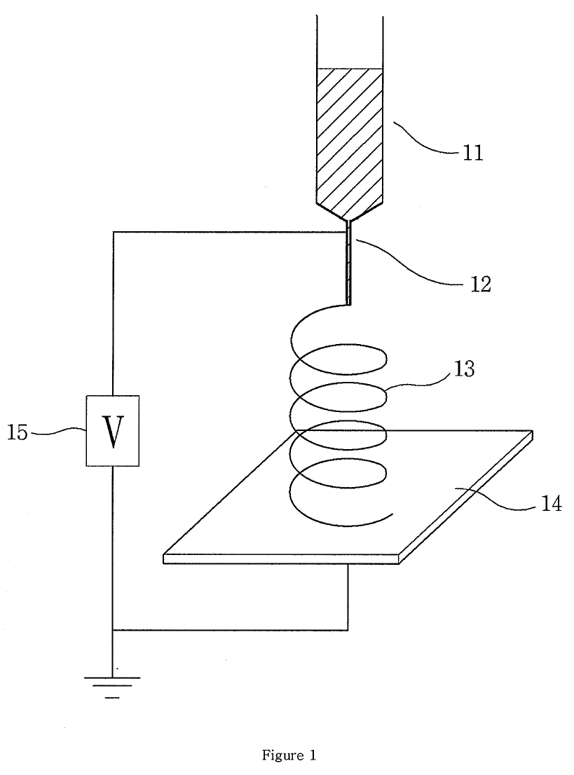

FIG. 1 is a diagram of an illustrative embodiment of an extraction of a nano fiber. As depicted, the extraction may include extracting the nano fiber by electro-spinning.

Electro-spinning may be a process for consecutively making fibers of a specific surface area, and generally, may eject electro-spinning solution 11 via a nozzle 12 while supplying an electric field to the electro-spinning solution 11. In electro-spinning, a voltage source 15 may supply a high voltage between the nozzle 12, which is filled with a solution for extracting a fiber, and a substrate 14 to cause the extraction of an ultrafine fiber 13 of nanoscale size from the solution. The nano or ultrafine fiber 13 may be mounted on the substrate 14 while solvents are vaporized from the electro-spinning solution.

The solution for electro-spinning may be formed by mixing sol-gel precursor of metal oxide and a proper polymer solution. The polymer may increase the viscosity of the solution so that the fiber may be formed on extraction. A metal oxide precursor for the electro-spinning solution may include ions such as, but not limited to, Zn, Sn, Ti, In, or W. In general, variety of precursors may be used that may be capable of forming metal oxides such as, but not limited to, ZnO, In₂O₃, SnO₂, WOₓ, TiO₂, etc. through, for example, a heat treatment after reacting with the polymer, and accordingly the claimed subject matter is not limited in these respects.

The polymer may be selected from, at least one of, for example, polyurethan copolymer comprising polyurethan and polyetherurethan, cellulose derivatives such as cellulose acetate, cellulose acetate butylrate and cellulose acetate, polymethylmethacrylrate (PMMA), polymethylarcrylrate (PMA), polyarcryl copolymer, polyvinylacetate (PVAc), polyvinylacetate copolymer, polyvinylalcohol (PVA), polyperpurylalcohol (PPFA), polystyrene (PS), polystyrene copolymer, polyethylene oxide (PEO), polypropyleneoxide (PPO), polyethylene copolymer, polypropyleneoxide copolymer, polycabonate (PC), polyvinyl chloride (PVC), polycaprorakton, and polyvinylpirolidon (PVP).

In general, the electro-spinning solution may include a variety of solutions capable of forming a nano fiber using electro-spinning.

In an embodiment, the electro-spinning solution may be a polymer solution that may include nano loads. In some examples, the electro-spinning solution may be a nano load solution including nano loads such as, but not limited to, WO_{2.72}, ZnO, In₂O₃, SnO₂, TiO₂, or any combination thereof. In an example, the nano load may be an n type metal oxide having a high aspect ratio, and accordingly, the claimed subject matter is not limited in these respects.

The kinds of the polymer solution comprising the nano loads and the production method thereof may be easily adopted by a skilled person in the art in light of the present disclosure and according to the kind of gas that may be detected by the sensor.

The extractor of the nano fiber and the method thereof may not be restricted electro-spinning. Numerous methods that may extract the nano fiber may be used.

### An Arrangement of Nano Fiber

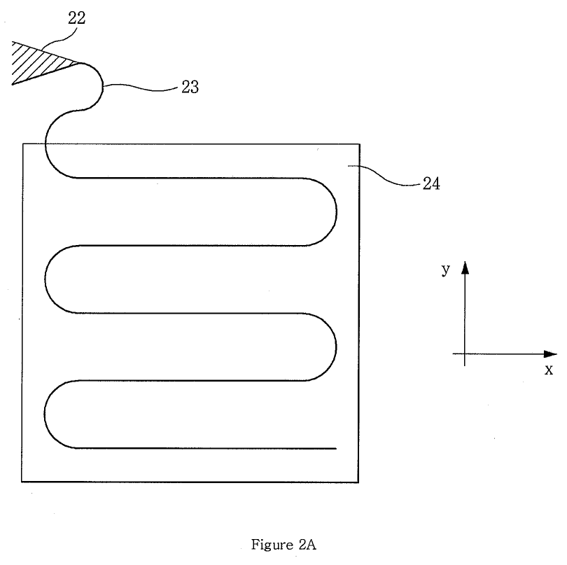

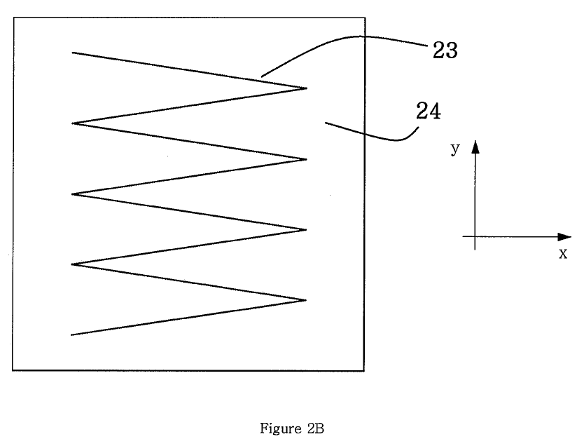

FIG. 2A is a diagram of an illustrative embodiment of a nano fiber arranged on a substrate. FIG. 2B is a diagram of another illustrative embodiment of a nano fiber arranged on a substrate. As depicted, a nano fiber extracted from an extractor 22 may be arranged on a substrate 24 in a particular form or shape, such as, but not limited to, the arranged forms as shown in FIG. 2A or 2B.

A nano fiber 23 may be extracted from the extractor 22, and, during extraction, the extractor 22 and the substrate 24 may be moved relative to one another by a driving device (non-shown). In other words, the extractor 22 may extract the nano fiber and move relative to the substrate 24, and accordingly, the nano fiber may be arranged on the substrate 24 with a consecutive linear structure and making a particular track.

In various embodiments, the relative movement between the extractor 22 and the substrate 24 may be provided by one of the extractor or the substrate moving while the other may remain fixed. In other embodiments, the extractor 22 and the substrate 24 may be moved simultaneously. The driving device may be mounted on the extractor 22, the substrate 24 or both the extractor 22 and the substrate 24. A wide variety of driving devices may be used such as devices including a driving unit (for example, a motor) for relatively moving the extractor 22 and the substrate 24 two-dimensionally or three-dimensionally. The driving device may directly move the extractor 22 or the substrate 24, or may indirectly move the extractor 22 or the substrate 24 by moving a holder connected to the extractor 22 or the substrate 24.

The relative movement of the extractor 22 and the substrate 24 may be controlled by a control means. The control means may receive the required track of the nano fiber 23 and calculates the relative movement corresponding to the track, and it may control the relative movement between the extractor 22 and the substrate 24.

An arrangement device for arranging the extractor 22 and the substrate 24 may be included that may align and arrange the extracted nano fiber 23 on the substrate 24. An arrangement of the extractor 22 and the substrate 24 may be performed before extracting the nano fiber 23 or during the extraction of the nano fiber 23 when an error in the arrangement status of the nano fiber 23 occurs. While confirming the arrangement status of the arranged nano fiber 23, the error may be detected and transmitted to the driving device. The driving device may control the relative movement of the extractor 22 and the substrate 24 and may correct the error.

Examples of the movement by the driving device will be explained with reference to FIG. 2A.

First, the case where the substrate 24 is moved while the extractor 22 is fixed may be considered. The extraction of the nano fiber 23 may start at the bottom right side of the substrate 24. When the extraction of the nano fiber 23 starts, the substrate 24 may move along the +x axis, and when the nano fiber 23 reaches the bottom left side of the substrate 24, the substrate 24 may be moved along the −y axis and then along the −x axis. If nano fiber 23 reaches at the end of the right side of the substrate 24, the substrate may be moved along the −y axis and then the +x axis. By such movement, the nano fiber may be arranged on the substrate in the form depicted in FIG. 2A, or, the zigzag form depicted in FIG. 2B. The arrangement form of the nano fiber is not restricted to any specific form, and a wide variety of forms may be used.

In another example, the substrate 24 may be fixed, and the extractor 22 may be moved or the substrate 24 and the extractor 22 may be moved simultaneously. In a similar manner to the movement of the substrate 24, the extractor 22 or the extractor 22 and the substrate 24 may be moved to arrange the nano fiber 23 on the substrate 24, for example, according to a specific track depicted in FIG. 2A or 2B.

In various examples, the arrangement process of the nano fiber 23 may be performed consecutively without ceasing the extraction of the nano fiber 23 or they may be formed in segments and in row intervals.

### Forming an Electrodes

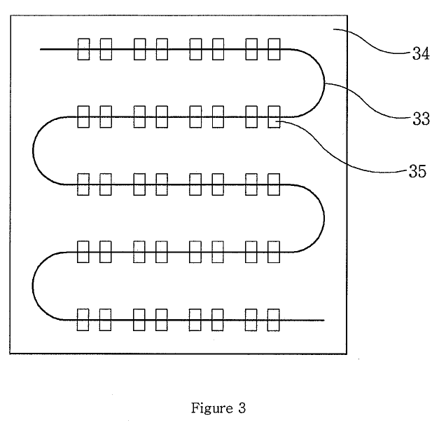

FIG. 3 is a diagram of an illustrative embodiment of a plurality of electrodes formed on a substrate. As depicted, a plurality of electrodes 35 may be formed at positions related to an arranged nano fiber 33. For example, on a substrate 34 for producing a sensor, an electrode layer such as an indium tin oxide (ITO) may be laminated, and the nano fiber 33 may be arranged in a specific form on the electrode layer. On the position where the nano fiber 33 may be arranged, the plurality of electrodes 35 may be formed in an arrangement as depicted in FIG. 3. Forming the plurality of electrodes 35 may be implemented by, for example, an exposure process. The plurality of electrodes 35 may be formed by removing portions of the electrode layer and leaving other portions of the electrode layer to form the plurality of electrodes 35.

In some examples, the electrodes 35 may be formed before arranging the nano fiber. In such examples, the plurality of electrodes 35 may be formed on the substrate 34 and the nano fiber 33 may be arranged on the positions corresponding to the positions of the plurality of electrodes 35. Accordingly, the driving device may move the extractor (not shown) and/or the substrate 34 such that the nano fiber 33 may be arranged on the plurality of electrodes 35.

The arrangement form of the plurality of electrodes 35 may include a wide variety of arrangements. In some examples, the arrangement of the electrodes 35 may be made upon considering conditions such as, but not limited to, a distance between two electrodes for configuring one sensor, a distance between electrodes that may be required to not damage the electrodes when dividing the substrate, and the number of sensors to be produced on one substrate. Accordingly, a skilled person in the art in light of the present disclosure may appreciate there may be arrangements of electrodes 35 in various forms satisfying the above conditions, other than those described.

### Heat Treatment

After a nano fiber is arranged on the plurality of electrodes, a heat treatment may be performed. Heat treatment may eliminate a solvent element in the nano fiber and may form a porous nano fiber. Heat treatment may be implemented according to the kind of precursor included in the electro-spinning solution. In one embodiment, an isopropyl alcohol solution including tungsten oxide nano load may be heat-treated at about 100° C. and held at a vacuum for 10 hours. The heat treatment conditions may include wide variety of conditions based at least in part on the kind of polymer solution used.

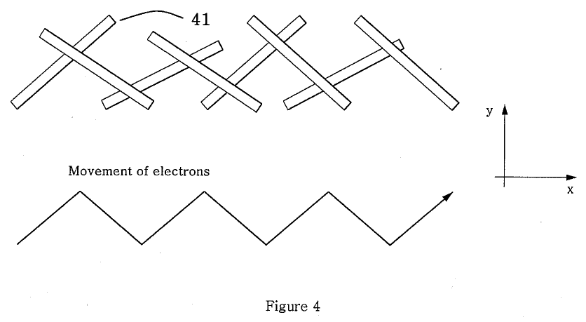

The nano fiber formed by the heat treatment may include nano loads, and the nano loads may be arranged with a direction. FIG. 4 is diagram of an illustrative embodiment of an arrangement form of a nano load including a nano fiber. As depicted, nano loads 41 may be arranged to have small inclination from the x axis, such that the nano loads 41 may have a direction substantially along the x axis. The nano loads 41 may be formed by electro-spinning with the substrate and the radiation relatively fixed, and may form a web of all directions for an entire 2-dimension without substantial regular direction, whereas the nano fiber may be arranged with regular direction, and the nano loads 41 may be arranged with regular direction according to a movement direction as indicated. Accordingly, arranging the nano fiber on the plurality of the electrodes may include the fiber being arranged with the direction on x axis so that the nano loads 41 in the fiber may also be directional along the x axis.

Such an arrangement of the nano loads 41 may increase the movement rate of electrons that move through the nano loads 41. The electrons may be transmitted through the contact of the nano loads 41 in the sawlike shape, and the transmission rate of the electrons in a sensor having nano loads 41 may be faster than in a sensor having nano particle. The transmission of the electrons through such nano loads 41 may make the response rate of the sensor faster.

### Deposition of a Metal Layer

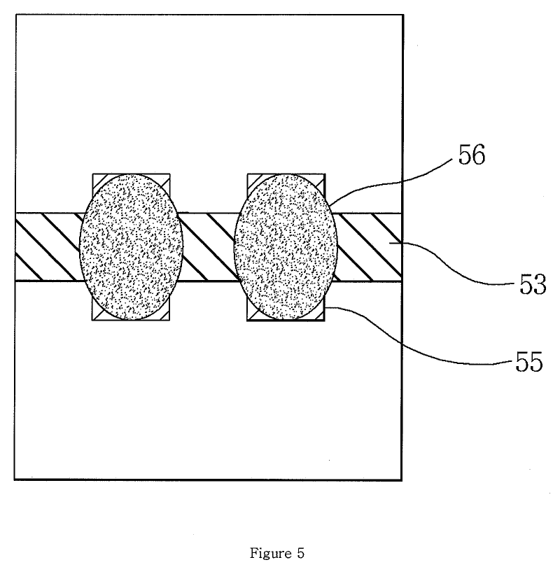

FIG. 5 is a top view of an illustrative embodiment of a sensor unit including a metal layer. As depicted, a conductive metal layer 56 may be deposited on a nano fiber 53 and electrodes 55. The metal layer 56 may increase electrical connectivity, and may be selectively deposited on the electrodes 55. The metal layer 56 may be, for example, a layer including gold. For deposition of the metal layer 56, any of a variety of deposition methods may be used.

To increase the adhesion of the nano fiber 53 and electrodes 55, a heat compression process may be used.

### Division of a Substrate

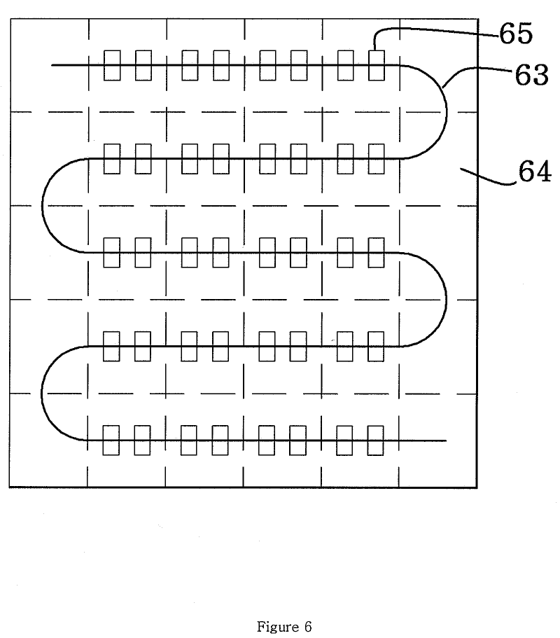

FIG. 6 is a diagram of an illustrative embodiment of a separation line of a substrate. Referring to FIG. 6, a division process of the substrate is disclosed. As depicted, a sensor unit may be configured with two electrodes 65 and a nano wire structure 64 that may connect the electrodes 65. A substrate 64 may be divided such that at least two electrodes 65 and a nano wire structure 64 connecting the electrodes 65 may be included on each substrate portion. The substrate 64 may be divided into, for example, the regions indicated with dotted lines in FIG. 6. In other examples, the substrate 64 may be divided with the portions including two or more sensor units. For the division of the substrate 64, any of a variety of methods may be used, such as, but not limited to, providing a pressure to divide the substrate 64 after forming a scribe-line.

Other than the above various exemplary embodiments, a person having ordinary skill in the art in light of the present disclosure may recognize that modification, substitution, or addition to the described embodiments and combinations thereof may be possible. Various apparatus and the methods for extracting the nano fiber may be used, and for the polymer solution including the nano load, various kinds of the solutions may be used. A skilled person in the art in light of the present disclosure may recognize that the driving device for moving the extractor and the substrate relative to one another may be applied without restriction to the described mechanical construction and there may be various possibilities for the control device. Moreover, the substrate may be divided using a variety of technologies. Additionally, although gas may be the object to be detected by the sensor, a skilled person in the art in light of the present disclosure may understand that the described sensors may be applicable to detection of various analytes such as, but not limited to, bio molecules.

From the foregoing, it will be appreciated that various embodiments of the present disclosure have been described herein for purposes of illustration, and that various modifications may be made without departing from the scope and spirit of the present disclosure. Accordingly the various embodiments disclosed herein are not intended to limiting, with the true scope and spirit being indicated by the following claims.

What is claimed is:

1. An apparatus for preparing a sensor comprising,
a substrate;
an extractor configured to extract a nano fiber from a solution; and
a driving device configured to provide relative movement between the substrate and the extractor.

2. The apparatus of claim 1, wherein the nano fiber is disposed on the substrate with relative movement between the substrate and the extractor.

3. The apparatus of claim 2, wherein the solution comprises a polymer solution including a plurality of nano loads.

4. The apparatus of claim 3, wherein the plurality of nano loads are substantially aligned with a direction that the nano fiber is arranged on the substrate.

5. The apparatus of claim 2, wherein a plurality of electrodes are disposed on a portion of the substrate and adjacent to the nano fiber.

6. The apparatus of claim 5, further comprising,
a dividing device configured to divide the substrate at a second portion of the substrate that does not include the plurality of electrodes.

7. The apparatus of claim 5, further comprising,
a deposition device configured to deposit a conductive metal layer on the plurality of electrodes.

8. The apparatus of claim 2, wherein the nano fiber is arranged on the substrate consecutively.

9. The apparatus of claim 1, further comprising,
a heating device configured to heat the nano fiber.

10. A method for preparing a sensor comprising,
arranging a nano fiber extracted from a solution on a substrate, wherein the arranging the nano fiber includes moving the nano fiber relative to the substrate; and
forming an electrode on a position of the substrate and in contact with the nano fiber.

11. The method of claim 10, further comprising,
heating the nano fiber.

12. The method of claim 11, further comprising,
depositing a conductive metal layer on the electrode, after the heating the nano fiber.

13. The method of claim 12, further comprising,
dividing the substrate such that the electrode is avoided.

14. The method of claim 10, wherein the solution comprises a polymer solution including nano loads.

15. The method of claim 14, wherein the nano loads are substantially aligned with a direction that the nano fiber is arranged on the substrate.

16. The method of claim 10, wherein said arranging the nano fiber comprises arranging the nano fiber on the substrate consecutively.

17. A method for preparing a sensor comprising,
forming an electrode on a substrate; and
arranging a nano fiber extracted from a solution to a position on the substrate corresponding to the electrode, wherein arranging the nano fiber includes moving the nano fiber relative to the substrate.

18. The method of claim 17, further comprising,
heating the nano fiber.

19. The method of claim 18, further comprising,
depositing a conductive metal layer on the electrode, after the heating the nano fiber.

20. The method of claim 19, further comprising,
dividing the substrate such that the electrode is avoided.

21. The method of claim 17, wherein the solution comprises a polymer solution including nano loads.

22. The method of claim 21, wherein the nano loads are substantially aligned with a direction that the nano fiber is arranged on the substrate.

23. The method of claim 17, wherein said arranging the nano fiber comprises arranging the nano fiber on the substrate consecutively.

24. A sensor comprising,
a substrate including an electrode; and
a nano structure on the substrate and in a position corresponding to the electrode, wherein the nano structure includes a nano load, and wherein the nano load is substantially aligned with a direction that the nano structure is arranged on the substrate.

25. A sensor according to claim 24, further comprising,
a conductive metal layer disposed in a position corresponding to the electrode.
